(19) United States
(12) Patent Application Publication
(10) Pub. No.: US 2014/0050827 A1
(43) Pub. Date: Feb. 20, 2014

(54) NON-INVASIVE MRI SYSTEM FOR ANALYZING QUALITY OF SOLID FOOD PRODUCTS ENVELOPED BY FLEXIBLE ALUMINUM FOIL WRAPPER AND METHODS THEREOF

(71) Applicant: ASPECT IMAGING LTD., Shoham (IL)

(72) Inventor: Uri RAPOPORT, Moshav Ben Shemen (IL)

(21) Appl. No.: 13/906,853

(22) Filed: May 31, 2013

Related U.S. Application Data
(60) Provisional application No. 61/683,287, filed on Aug. 15, 2012.

(51) Int. Cl. G01N 24/08

(52) U.S. Cl. CPC G01N 24/08
USPC 426/232; 324/318; 324/309

(57) ABSTRACT

The present invention provides a quality control system characterized by:
a. a line of substantially-solid food-products, said products at least partially enclosed in a flexible aluminum foil wrapper and randomly-orientated on said line;
b. an MRI device adapted to image each of said products on said line; said MRI is in communication with a computer readable medium adapted to (i) store at least one computer-retrievable standardized parameter related with a standard product; (ii) analyze said MRI thereby providing an online parameter; (iii) compare said online parameter with said predefined standardized parameter; and thereby (iv), detect defects in said products.

### FIELD OF THE INVENTION

The present invention discloses a non-invasive MRI system for analyzing the quality of solid food products enveloped in an aluminum foil wrapper and methods thereof.

### BACKGROUND OF THE INVENTION

Foodstuffs such as chocolate which consist of emulsions are subject to phase separation, where the phases in the emulsion (usually water and oil) separate. Such separation causes a surface defect commonly referred to as “bloom” or “blooming”. In chocolate products such as chocolate bars, two kinds of bloom are seen, “fat bloom” and “sugar bloom”. In “fat bloom”, fat migrates to the surface, forming an unsightly whitish or pale brown deposit on the surface of the chocolate. In “sugar bloom”, water which migrates to or condenses on the surface evaporates, leaving sugar crystals which form a whitish deposit with a speckled appearance. Neither type of bloom renders the chocolate inedible and neither significantly affects the taste, although “fat bloom” may affect the texture of the product. However, the often mouldy-looking deposits are unsightly and can render the product unsalable or cause return of product as not being of merchantable quality.

Chocolate bloom is most frequently the result of poor manufacturing conditions (incomplete mixing causing fat bloom), poor packing conditions (high humidity causing sugar bloom) or poor storage conditions (high temperatures causing fat bloom) and can be minimized through care in manufacture, packing and storage.

Product can be sampled at a distribution site or at a retail site to estimate the fraction of chocolate products in a given batch which exhibit bloom and, if too high a fraction of the samples exhibit bloom, the batch can be rejected. However, this causes wastage of product for sampling and also requires rejection of an entire batch if the fraction is too large, although the majority of the product may well be in salable condition.

Many techniques are available to check products of various kinds for defects. For example, patent application WO08016309A examines food products for surface defects. In it, reflected light from a food product on a production line is sensed by a digital camera or an imaging spectrometer to detect surface differences, subsurface differences, or shape differences between a defective sample and a non-defective model of the food products. Patent application EP2345330 functions similarly, but uses a TV camera for the sensor. Neither of these can inspect most types of wrapped product, as light cannot pass through most food wrappings.

Another possible method of inspecting food product is NMR. NMR is based on the magnetic properties of the atomic nuclei of materials. In NMR, the sample to be analyzed is exposed to a strong magnetic field. Nuclei with magnetic moment (spin), such as hydrogen, potassium or ¹³Carbon, will absorb electromagnetic radiation at a frequency characteristic of the isotope. The resonant frequency, energy of the absorption, and the intensity of the signal are proportional to the strength of the magnetic field. For example, in a 21 Tesla magnetic field, protons resonate at 900 MHz. When this absorption occurs, the nucleus is described as being in resonance. Different atomic nuclei within a molecule resonate at different (radio) frequencies for the same magnetic field strength. The observation of such magnetic resonance frequencies of the nuclei present in a molecule allows any trained user to discover essential chemical and structural information about the molecule.

If the main magnetic field is non-uniform, then the resonant frequency for a given chemical species will be different in different parts of the sample, thereby providing information on the location of the species within the sample.

U.S. Pat. No. 7,397,241 and U.S. patent application US 2004/0058559 describe methods by which the percentage of one or more material components can be are determined in a sample by NMR. They can be used for quality control of the quality of mixtures and for determining the proportions of different material components in a sample. The methods are designed for static, unmoving samples and do not describe any way of measuring samples on a moving production line.

U.S. Pat. No. 5,371,464 and U.S. Pat. No. 5,519,319 describe methods for determining the physical parameters of polymeric samples, such as the degree of crosslinking in rubbers. Both methods are designed for static, unmoving samples, determine bulk rather than surface properties of the material, and are not meant to be used with materials wrapped in metal foil.

German patent application DE102010021260 describes a method of determining quality characteristics of a moving sample using NMR. Materials that may be analyzed include polymer materials such as elastomers, duromers, thermoplastic elastomers, thermoplastics, metallic materials or textile materials. Physical characteristics such as crystallization or orientation may be determined for the materials, as well as both the inner and outer geometric dimensions of a sample. Again, the process determines the bulk properties of the material and is not meant to be used with materials wrapped in metal foil.

U.S. patent application US2002/048610 describes a method of screening samples for such properties as improved bioavailability, solubility, stability, delivery, and processing and manufacturing characteristics. It is not intended to be used on a production line, determines bulk rather than surface properties, and is not meant to be used with materials wrapped in metal foil.

U.S. Pat. No. 6,333,629 describes a method of inspecting liquids such as ultra heat treated (UHT) milk or juice in substantially rigid cartons, where the cartons comprises a metal layer, which can be aluminum or which can contain aluminum. The cartons are aligned such that at least a substantial portion of the electrically conductive barrier is oriented transversely to an orientation of the RF magnetic field during excitation.

Therefore, there is a long-felt need for a method of checking the surface of wrapped slid food products, especially chocolate products, which does not damage the product being sampled and which does not require rejection of an entire batch when only a fraction of the batch is defective, especially exhibits bloom.

### SUMMARY OF THE INVENTION

It is an object of the present invention to disclose a non-invasive MRI system for analyzing quality of food products, especially solid chocolate food products, enveloped by aluminum foil wrapper and methods thereof.

It is one object of the present invention to provide a system for non-invasively inspecting a solid food product comprising:
1. a magnetic resonance imaging device configured to generate at least one magnetic resonance image of said solid food product, said solid food product at least substantially enclosed in a substantially flexible aluminum foil wrapper;
2. at least one magnetic resonance image of at least one standardized control sample of said solid food product, said standardized control sample of said solid food product at least substantially enclosed in a substantially flexible aluminum foil wrapper; and
3. a processor configured to compare said at least one magnetic resonance image of said solid food product to said at least one magnetic resonance image of said at least one standardized control sample of said solid food product;
   wherein defects can be detected on the surface of said wrapped solid food product, independent of the orientation of said wrapped solid food product in said a magnetic resonance imaging device.

It is another object of the present invention to provide the system for non-invasively inspecting a solid food product as defined above, further comprising a magnetic resonance probe for supporting said Al foil wrapper in said magnetic resonance imaging device during a magnetic resonance measurement of said solid chocolate food product.

It is another object of the present invention to provide the system for non-invasively inspecting a solid food product as defined above, wherein said Al foil wrapper has a thickness in the range of approximately 6 μm to 20 μm.

It is another object of the present invention to provide the system for non-invasively inspecting a solid food product as defined above, wherein said magnetic resonance device generates a magnetic field intensity of approximately 1 Tesla in a region of interest.

It is another object of the present invention to provide the system for non-invasively inspecting a solid food product as defined above, wherein said magnetic field intensity has a skin depth of approximately 13 μm in said Al foil wrapper.

It is another object of the present invention to provide the system for non-invasively inspecting a solid food product as defined above, wherein said magnetic resonance imaging device is an MRD device.

It is another object of the present invention to provide the system for non-invasively inspecting a solid food product as defined above, wherein said Al wrapping foil has a skin depth of approximately 13 μm in an RF frequency range of approximately 42.5 MHz to 45 MHz.

It is another object of the present invention to provide the system for non-invasively inspecting a solid food product as defined above, wherein items of solid food product are inspected to determine whether the wrapping properly envelops the solid food product.

It is another object of the present invention to provide the system for non-invasively inspecting a solid food product as defined above, wherein spoilage is detected in a solid food product.

It is another object of the present invention to provide a system for non-invasively inspecting a solid chocolate food product comprising:
1. a magnetic resonance imaging device configured to generate at least one magnetic resonance image of said solid chocolate food product, said solid chocolate food product at least substantially enclosed in a substantially flexible aluminum foil wrapper;
2. at least one magnetic resonance image of at least one standardized control sample of said solid chocolate food product, said standardized control sample of said solid chocolate food product at least substantially enclosed in a substantially flexible aluminum foil wrapper; and
3. a processor configured to compare said at least one magnetic resonance image of said solid chocolate food product to said at least one magnetic resonance image of said at least one standardized control sample of solid chocolate food product;
   wherein blooming can be detected on the surface of said wrapped solid chocolate food product independent of the orientation of said wrapped solid chocolate food product in said a magnetic resonance imaging device.

It is another object of the present invention to provide the system for non-invasively inspecting a solid chocolate food product as defined above, further comprising a magnetic resonance probe for supporting said Al foil wrapper in said magnetic resonance imaging device during a magnetic resonance measurement of said solid chocolate food product.

It is another object of the present invention to provide the system for non-invasively inspecting a solid chocolate food product as defined above, wherein said Al foil wrapper has a thickness in the range of approximately 6 μm to 20 μm.

It is another object of the present invention to provide the system for non-invasively inspecting a solid chocolate food product as defined above, wherein said magnetic resonance device generates a magnetic field intensity of approximately 1 Tesla in a region of interest.

It is another object of the present invention to provide the system for non-invasively inspecting a solid chocolate food product as defined above, wherein said magnetic field intensity has a skin depth of approximately 13 μm in said Al foil wrapper.

It is another object of the present invention to provide the system for non-invasively inspecting a solid chocolate food product as defined above, wherein said magnetic resonance imaging device is an MRD device.

It is another object of the present invention to provide the system for non-invasively inspecting a solid chocolate food product as defined above, wherein said Al wrapping foil has a skin depth of approximately 13 μm in an RF frequency range of approximately 42.5 MHz to 45 MHz.

It is another object of the present invention to provide the system for non-invasively inspecting a solid chocolate food product as defined above, wherein items of solid food product are inspected to determine whether the wrapping properly envelops the solid food product.

It is another object of the present invention to provide the system for non-invasively inspecting a solid chocolate food product as defined above, wherein spoilage is detected in a solid food product.

It is another object of the present invention to provide a method for non-invasively inspecting a solid food product comprising:
1. acquiring a system for non-invasively inspecting a solid food product, said system comprising:
   a. a magnetic resonance imaging device configured to generate at least one magnetic resonance image of said solid food product, said solid food product at least substantially enclosed in a substantially flexible aluminum foil wrapper; and
   b. a processor configured to compare said at least one magnetic resonance image of said solid food product to at least one magnetic resonance image of at least one standardized control sample of said solid food product;
2. making at least one magnetic resonance image of at least one standardized control sample of said solid food product, said standardized control sample of said solid food product at least substantially enclosed in a substantially flexible aluminum foil wrapper;
3. making at least one magnetic resonance image of said solid food product, said solid food product at least substantially enclosed in a substantially flexible aluminum foil wrapper;
4. comparing said at least one magnetic resonance image of said solid food product with said at least one image of said at least one standardized control sample of said solid food product;
   wherein defects can be detected on the surface of said wrapped solid food product, independent of the orientation of said wrapped solid food product in said a magnetic resonance imaging device.

It is another object of the present invention to provide the method for non-invasively inspecting a solid food product as defined above, further comprising a step of storing said at least one magnetic resonance image of at least one standardized control sample of said solid chocolate food product.

It is another object of the present invention to provide the method for non-invasively inspecting a solid food product as defined above, further comprising a step of providing a magnetic resonance probe for supporting said Al foil wrapper in said magnetic resonance imaging device during said magnetic resonance measurement of said solid food product.

It is another object of the present invention to provide the method for non-invasively inspecting a solid food product as defined above, further comprising a step of selecting said Al foil wrapper to have a thickness in the range of approximately 6 μm to 20 μm.

It is another object of the present invention to provide the method for non-invasively inspecting a solid food product as defined above, further comprising a step of generating a magnetic field intensity of approximately 1 Tesla in a region of interest.

It is another object of the present invention to provide the method for non-invasively inspecting a solid food product as defined above, further comprising a step of generating a magnetic field, wherein said magnetic field intensity has a skin depth of approximately 13 μm in said Al foil wrapper.

It is another object of the present invention to provide the method for non-invasively inspecting a solid food product as defined above, further comprising a step of selecting an MRD device as said magnetic resonance imaging device.

It is another object of the present invention to provide the method for non-invasively inspecting a solid food product as defined above, further comprising a step of establishing a skin depth of approximately 13 μm in said Al wrapping foil; RF frequency range of said magnetic resonance imaging device being approximately 42.5 MHz to 45 MHz.

It is another object of the present invention to provide the method for non-invasively inspecting a solid food product as defined above, further comprising a step of inspecting items of solid food product to determine whether the wrapping properly envelops the solid food product.

It is another object of the present invention to provide the method for non-invasively inspecting a solid food product as defined above, further comprising a step of detecting spoilage in a solid food product.

It is another object of the present invention to provide a method for non-invasively inspecting a solid chocolate food product comprising:
1. acquiring a system for non-invasively inspecting a solid chocolate food product, said system comprising:
   a. a magnetic resonance imaging device configured to generate at least one magnetic resonance image of said solid chocolate food product, said solid chocolate food product at least substantially enclosed in a substantially flexible aluminum foil wrapper; and
   b. a processor configured to compare said at least one magnetic resonance image of said solid chocolate food product to at least one magnetic resonance image of at least one standardized control sample of said solid chocolate food product;
2. making at least one magnetic resonance image of at least one standardized control sample of said solid chocolate food product, said standardized control sample of said solid chocolate food product at least substantially enclosed in a substantially flexible aluminum foil wrapper;
3. making at least one magnetic resonance image of said solid chocolate food product, said solid chocolate food product at least substantially enclosed in a substantially flexible aluminum foil wrapper;
4. comparing said at least one magnetic resonance image of said solid chocolate food product with said at least one image of said at least one standardized control sample of said solid chocolate food product;
   wherein defects can be detected on the surface of said wrapped solid chocolate food product, independent of the orientation of said wrapped solid chocolate food product in said a magnetic resonance imaging device.

It is another object of the present invention to provide the method for non-invasively inspecting a solid chocolate food product as defined above, further comprising a step of storing said at least one magnetic resonance image of at least one standardized control sample of said solid chocolate food product.

It is another object of the present invention to provide the method for non-invasively inspecting a solid chocolate food product as defined above, further comprising a step of providing a magnetic resonance probe for supporting said Al foil wrapper in said magnetic resonance imaging device during said magnetic resonance measurement of said solid chocolate food product.

It is another object of the present invention to provide the method for non-invasively inspecting a solid chocolate food product as defined above, further comprising a step of selecting said Al foil wrapper to have a thickness in the range of approximately 6 μm to 20 μm.

It is another object of the present invention to provide the method for non-invasively inspecting a solid chocolate food product as defined above, further comprising a step of generating a magnetic field intensity of approximately 1 Tesla in a region of interest.

It is another object of the present invention to provide the method for non-invasively inspecting a solid chocolate food product as defined above, further comprising a step of generating a magnetic field, wherein said magnetic field intensity has a skin depth of approximately 13 μm in said Al foil wrapper.

It is another object of the present invention to provide the method for non-invasively inspecting a solid chocolate food product as defined above, further comprising a step of selecting an MRD device as said magnetic resonance imaging device.

It is another object of the present invention to provide the method for non-invasively inspecting a solid chocolate food product as defined above, further comprising a step of establishing a skin depth of approximately 13 μm in said Al wrapping foil; RF frequency range of said magnetic resonance imaging device being approximately 42.5 MHz to 45 MHz.

It is another object of the present invention to provide the method for non-invasively inspecting a solid chocolate food product as defined above, further comprising a step of inspecting items of solid chocolate food product to determine whether the wrapping properly envelops the solid food product.

It is another object of the present invention to provide the method for non-invasively inspecting a solid chocolate food product as defined above, further comprising a step of detecting spoilage in a solid chocolate food product.

### BRIEF DESCRIPTION OF THE FIGURES

In order to better understand the invention and its implementation in practice, a plurality of embodiments will now be described, by way of non-limiting example only, with reference to the accompanying drawings, wherein

FIG. 1 depicts chocolate without and with bloom; FIG. 1A illustrates chocolate without bloom; and, 1B illustrates chocolate with bloom.

FIG. 2 schematically illustrates a magnetic resonance device and plots of signal change with time; FIG. 2A depicts a schematic plot of the spin-lattice signal; FIG. 2B depicts a schematic plot of the transverse relaxation signal; and FIG. 2C depicts a schematic of a sample in a NMR device.

FIG. 3 schematically illustrates energy absorption vs magnetic field frequency for a magnetic resonance measurement of a sample of a chocolate product; FIG. 3A depicts the NMR signal of a chocolate food product as a function of RF frequency, FIG. 3B depicts the spin-lattice signal for a sample of the food product where the spin-lattice relaxation time T₁ is approximately 0.14 s, and FIG. 3C depicts the transverse relaxation signal for a sample of the food product where the transverse relaxation time T₂ is approximately 0.08 s.

FIG. 4 schematically illustrates the decay of magnetic field strength with depth in a conductor; and

FIG. 5 illustrates the decrease in skin depth with increasing magnetic field strength.

FIG. 6 illustrates the variation in field strength with depth for a food product.

### DETAILED DESCRIPTION OF THE PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a non-invasive MRI system for analyzing the quality of solid food products, especially solid chocolate food products, enveloped by an aluminum foil wrapper and methods thereof.

The term ‘about’ hereinafter refers to ±20% of the defined measure.

The term ‘substantially’ hereinafter refers to more than of about 90%.

The term ‘plurality’ hereinafter refers to an integer greater than one.

The present invention provides a system and method for non-destructively checking for bloom on chocolate products and may also be used for checking for defects in or on other solid food products.

The system uses Nuclear Magnetic Resonance (NMR) imaging to determine the chemical state of the food product. In NMR, the sample to be imaged is placed in a strong static magnetic field. This aligns the spins of nuclei within the sample with the magnetic field. An oscillating magnetic field is then applied to the sample, with the frequency of oscillation of the field depending on the nucleus to be studied and the strength of the static magnetic field. The frequency of the oscillating magnetic field is usually between about 40 MHz and about 1000 MHz.

Resonant absorption by nuclear spins will occur only when electromagnetic radiation of the correct frequency (e.g., equaling the Larmor precession rate) is being applied to match the energy difference between the nuclear spin levels in a constant magnetic field of the appropriate strength. The energy of an absorbed photon is then E=h [symbol] where [symbol] is the resonance radiofrequency that the photon has to match (that is, the photon frequency has to be equal to the Larmor precession frequency [symbol] _{L} of the nuclear magnetization in the constant magnetic field B₀). Hence, a magnetic resonance absorption will only occur when ΔE=h [symbol] which is when [symbol] ₀=μB₀/(2π). Such magnetic resonance frequencies typically correspond to the radio frequency (or RF) range of the electromagnetic spectrum for magnetic fields up to ˜20 T. It is this magnetic resonant absorption which is detected in NMR.

The exact frequency which is needed will depend on shielding of the nucleus by the atom's electrons and therefore on the chemical state of the atom. The change in frequency between that needed for one chemical state and that needed for another is usually in the parts-per-million (PPM) range.

After the nuclei have equilibrated, the RF field can be removed and the decay of the alignment of the nuclei (the relaxation time) may be determined. Two different relaxation times are determined, T₁ and T₂. T₁, the “spin-lattice” or “longitudinal magnetic” relaxation time, refers to the mean time for an individual nucleus to return to the thermal equilibrium state of its spins. T₂ is the “transverse relaxation” time, the time for precessing nuclei to fall out of alignment with each other (returning the net magnetization vector to that of a non-precessing field) and stop producing a signal.

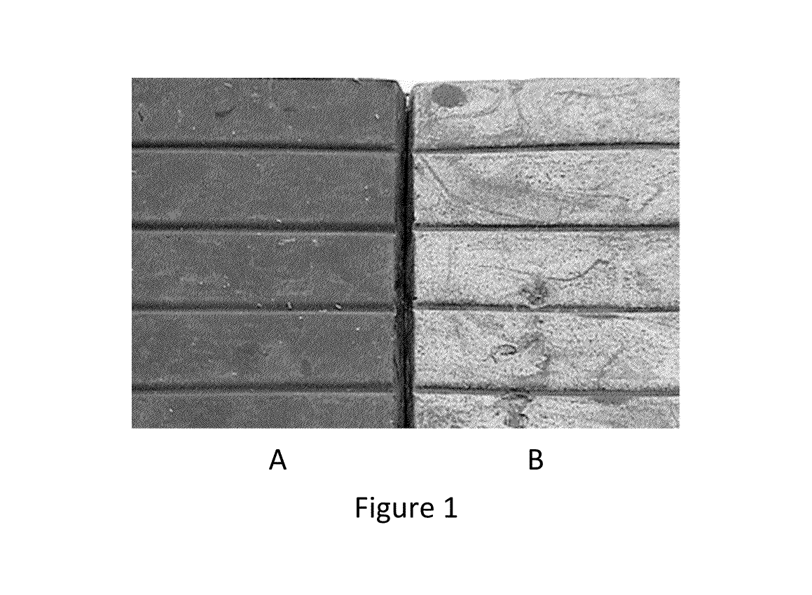

In reference to FIG. 1, FIG. 1A shows chocolate without bloom, whereas FIG. 1B shows chocolate with bloom.

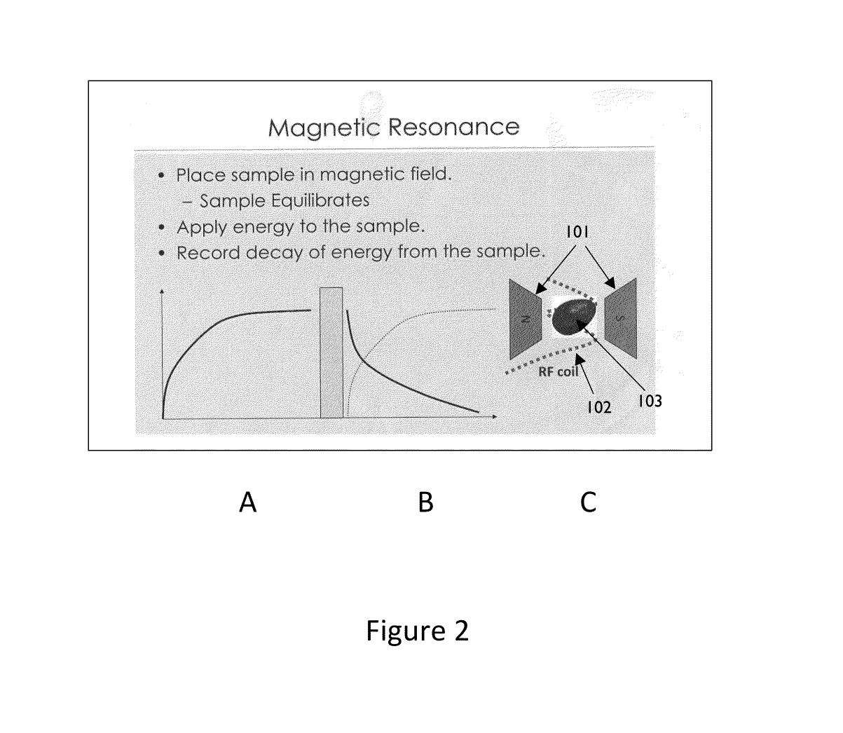

In reference to FIG. 2, FIG. 2A depicts a schematic plot of the spin-lattice signal, FIG. 2B depicts a schematic plot of the transverse relaxation signal, and FIG. 2C depicts a schematic of a sample in a NMR device. In FIG. 2C, the static magnets (101) and the RF coil (dotted line, 102) surround the sample (103).

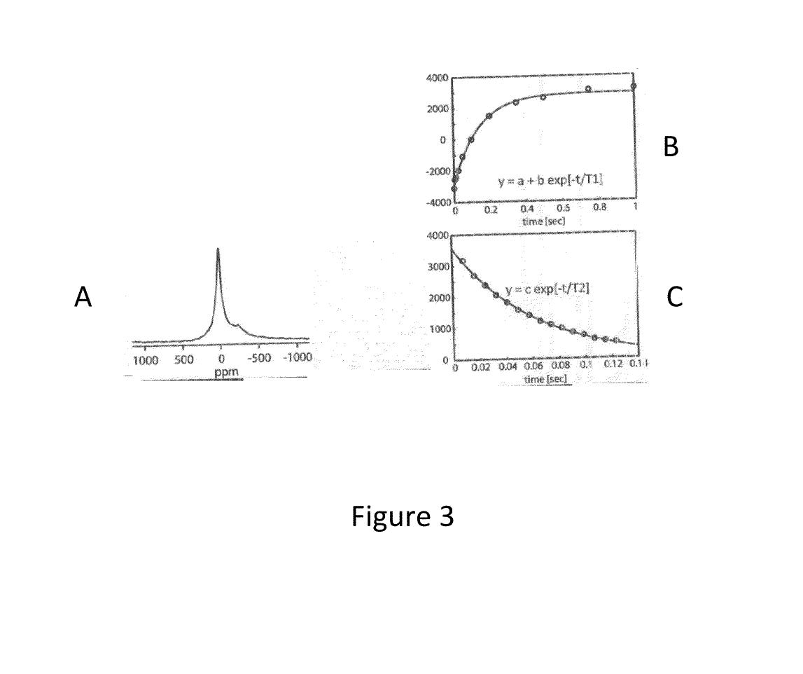

In reference to FIG. 3, FIG. 3A depicts the NMR signal of a chocolate food product as a function of RF frequency, FIG. 3B depicts the spin-lattice signal for a sample of the food product where the spin-lattice relaxation time T₁ is approximately 0.14 s, and FIG. 3C depicts the transverse relaxation signal for a sample of the food product where the transverse relaxation time T₂ is approximately 0.08 s.

If an electric or magnetic field is applied to the outside of a conductor, the magnetic field will tend to remain on the outside of the conductor, but it will induce electric and magnetic fields inside the conductor, with the fields' strength decreasing rapidly with depth. The depth to which the fields penetrate is called the skin depth δ, and is usually defined as the depth at which the field strength is 1/e times the field strength at the surface.

If the electric or magnetic field is a varying one, the field near the surface of the conductor will cause eddy currents in the conductor. These eddy currents oppose the change in the field and cause the effective resistance of the conductor to increase at higher frequencies where the skin depth is smaller.

The skin depth for a semi-infinite conductor is given by

$$δ = \frac{1}{\sqrt{π f μσ}} \qquad ( 1 )$$

Where δ is the standard depth of penetration, f is the frequency, μ is the magnetic permeability of the material and o is the electrical conductivity. As a non-limiting example, between 10 and 100 MHz in Aluminum, the skin depth is typically between about 8 and 30 μm.

Typical alloys used for foil in packaging applications include 1100, 1145, 1235, 8011, 8079, and 8111. The standard thickness of the aluminum foil used for packaging chocolate products ranges from about 10 to about 14 μm, although the thickness can vary between about 6.4 μm and 150 μm; patterns are normally applied on foils with a thickness above about 10 μm. Chocolate normally is wrapped in aluminum foil that is either unvarnished or varnished with clear varnish on one or both sides. It may also be laminated to paper or plastic films, but this is less common. Since the skin depth for Aluminum is on the order of typical thicknesses of aluminum foil used for wrapping chocolate food products, generating magnetic resonance images of a chocolate food product wrapped in a typical foil wrapper is feasible and, since the varnish and paper or plastic films are at least translucent to magnetic fields, they should not affect the ability to generate such magnetic resonance images.

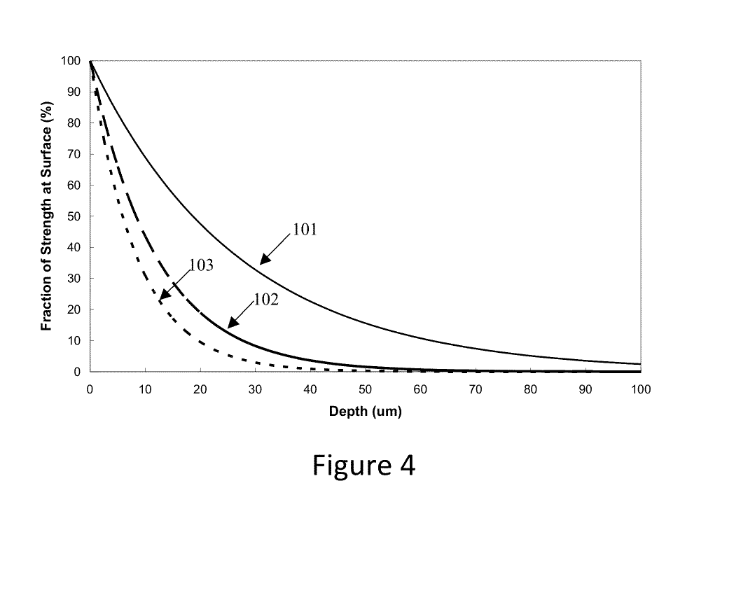

In reference to FIG. 4, the decrease in field strength with depth in the metal is shown for three different frequencies, 10 MHz (101), 50 MHz (101) and 100 MHZ (101).

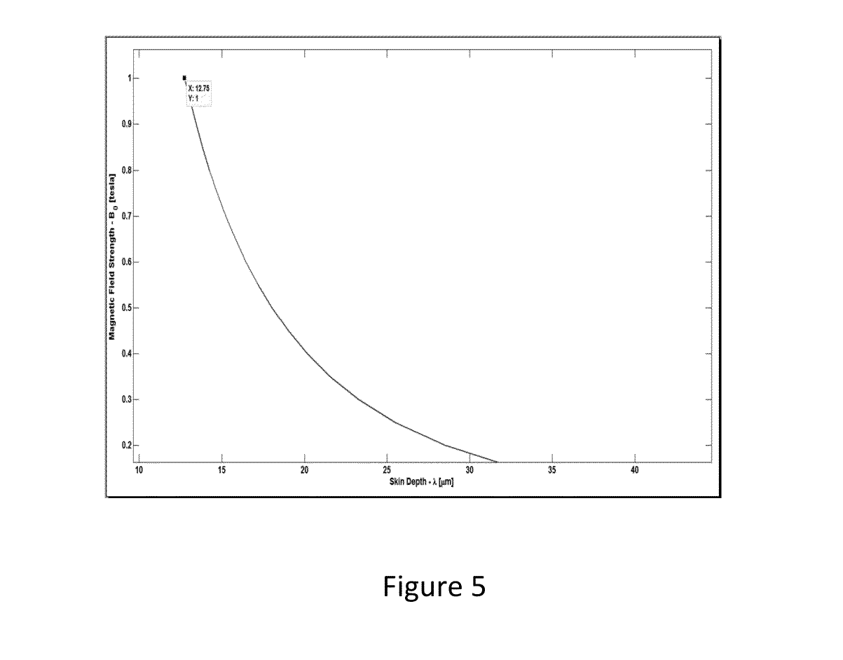

FIG. 5 depicts the variation in skin depth with magnetic field for magnetic fields typical of those used for NMR. For fields of less than 1 T, the skin depth is more than about 13 μm, so that, for typical chocolate packaging foils, a significant fraction (more than about 37%) of the magnetic field strength will entirely penetrate the foil packaging and will reach the underlying chocolate product.

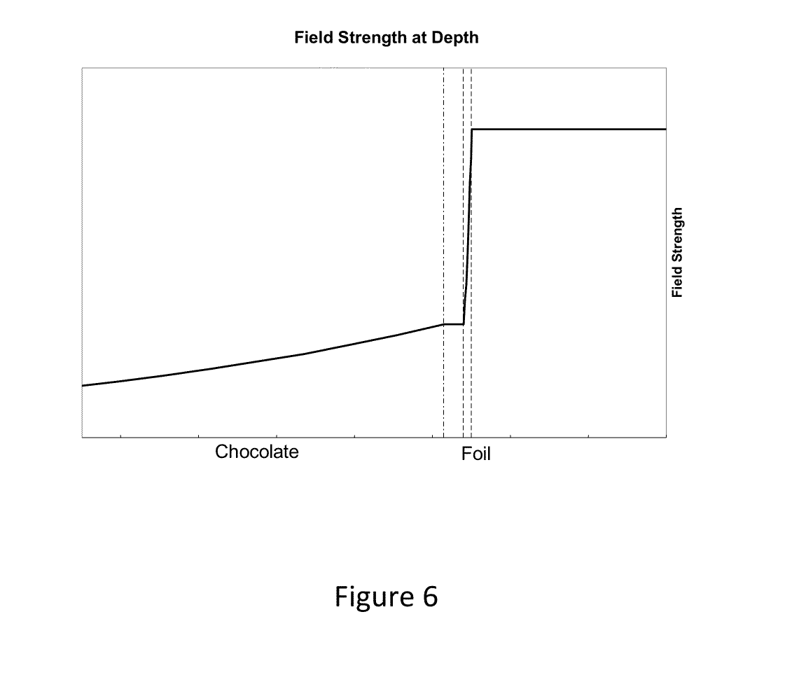

In reference to FIG. 6, the variation in field strength with depth is shown for a food product. The product, in this case a chocolate bar, is at the left, ending at the dot-dashed line. The foil is between the dashed lines. There is air between the chocolate bar and the foil (between the dot-dashed line and the dashed line) and outside the foil, to the right of the rightmost dashed line. The field has a constant intensity in the air gaps. The intensity drops rapidly in the foil, but remains of sufficient strength to excite atoms in the chocolate and provide an acceptable signal therefrom. The intensity will also drop inside the chocolate, although much more slowly than in the foil. The thickness of the foil and the absorption in the chocolate have been exaggerated for clarity.

If the frequency of the time-varying magnetic field is then chosen to be a resonant frequency typical of, for example, protons in fat, then the distribution of fats within the chocolate may be determined. If there is excess fat on the surface of the chocolate, blooming is present and the chocolate is rejected. Similarly, an NMR scan at a resonant frequency typical of protons in sugar may be used to identify chocolate products suffering from sugar bloom.

In embodiments of the system, the food product is substantially covered by the foil wrapper. In preferred embodiments, the food product is completely covered by the foil wrapper.

In one embodiment of the system, at least one magnetic resonance image of a high-quality sample of a wrapped solid food product, preferably a chocolate food product, is generated and stored. This provides an image of a standardized control sample, to which other items of the food product may be compared. A moving line transports items of the food product through a magnetic resonance imaging device (MRID) configured to generate at least one magnetic resonance image of each sample of the food product. This image is compared to that of the standardized control sample and, if the image of the item differs sufficiently from the image of the standardized control sample, the item has chocolate bloom. Items identified as having bloom can then be removed from the line or otherwise appropriately treated, so that products with bloom will not reach consumers.

Most NMR systems comprise a probe to apply the varying magnetic field to the item to be analyzed. The probe can also comprise a tuning capacitor, an rf transmission line, and methods to control such items in the sample environment as temperature, electromagnetic irradiation, field gradients, pressure, and orientation, rotation and location in the main magnetic field. Said probes can be located above the item to be analyzed, below it, on at least one side of it, or any combination thereof.

In another embodiment of the system, the magnetic resonance probe supports the aluminum foil wrapper within the magnetic resonance imaging device. This support probe can be part of the moving line, such that the item is carried through the MRID on the probe, or it can be fixed, such that the item is removed from the line, placed on the probe, imaged, and returned to the line. In some embodiments wherein the item is placed on a fixed probe, items showing bloom are not returned to the moving line, but are rerouted to a system designed for handling rejected product.

In a best embodiment of the system, the aluminum foil wrapper on the product has a thickness in the range of approximately 6 μm to approximately 20 μm.

In some embodiments of the system, the MRID generates a magnetic field intensity of approximately 1 Tesla in a region of interest.

In some embodiments of the system, the skin depth of the magnetic field in the aluminum foil wrapper is approximately 13 μm.

In some embodiments of the system, the skin depth is approximately 13 μm and the RF frequency range is approximately 42.5 MHz to approximately 45 MHz.

In some embodiments, the system is used for determining surface or near-surface defects in other foil-wrapped solid foodstuffs. Examples of foodstuffs which may be analyzed include, but are not limited to, chocolate coated products, both to determine the presence of chocolate blooming and to ensure that the product is fully coated with the chocolate. Products with a solid coating and a liquid filling can be examined to determine whether the coating has broken or the liquid filling has leaked.

Other defects in the product which can be identified include, but are not limited to, breaks and cracks therein; pits, holes and undesired air bubbles; badly-shaped product such as product with rounded rather than square corners; spoilage such as bacterial or insect infestations; and tears or other defects in the foil wrapper.

In yet another embodiment, product which is not properly wrapped can be identified. For a non-limiting example, certain types of candies are individually wrapped, then aggregated into bags, tins or cartons containing a plurality of items. Using the device of the present invention, the individual wrapped items can be inspected before aggregation and improperly wrapped items, where the wrapping does not completely envelop the item, can be removed before aggregation.

What is claimed is:

1. A quality control system characterized by:
a. a line of substantially-solid food-products, said products at least partially enclosed in a flexible aluminum foil wrapper and randomly-orientated on said line;
b. an MRI device adapted to image each of said products on said line; said MRI is in communication with a computer readable medium adapted to (i) store at least one computer-retrievable standardized parameter related with a standard product; (ii) analyze said MRI thereby providing an online parameter; (iii) compare said online parameter with said predefined standardized parameter; and thereby (iv), detect defects in said products.

2. A quality control method characterized by:
a. enclosing food products in an aluminum foil wrapper wherein said food product is substantially solid, wherein said aluminum foil wrapper is flexible;
b. MRI imaging at least one standardized product; analyzing said standardized MRI and providing a standardized parameter; communicating said MRI with a computer readable medium, thereby storing at least one computer-retrievable standardized parameter related to said standard product;
c. conveying a plurality of products on a line, said line passing through an MRI device;
d. MRI imaging each of said products on said line; analyzing said MRI and providing a parameter; comparing said online parameter with said predefined standardized parameter; and detecting defects in products.

3. The system for non-invasively inspecting a substantially solid food product according to claim 1, further comprising a magnetic resonance probe for supporting said Al foil wrapper in said magnetic resonance imaging device during a magnetic resonance measurement of said substantially solid food product.

4. The system for non-invasively inspecting a substantially solid food product according to claim 1, wherein said Al foil wrapper has a thickness in the range of approximately 6 μm to approximately 20 μm.

5. The system for non-invasively inspecting a substantially solid food product according to claim 1, wherein said magnetic resonance device generates a magnetic field intensity of approximately 1 Tesla in a region of interest.

6. The system for non-invasively inspecting a substantially solid food product according to claim 1, wherein said magnetic field intensity has a skin depth of approximately 13 μm in said Al foil wrapper.

7. The system for non-invasively inspecting a substantially solid food product according to claim 1, wherein said magnetic resonance imaging device is an MRD device.

8. The system for non-invasively inspecting a substantially solid food product according to claim 1, wherein said Al wrapping foil has a skin depth of approximately 13 μm in an RF frequency range of approximately 42.5 MHz to 45 MHz.

9. The system for non-invasively inspecting a substantially solid food product according to claim 1, wherein items of substantially solid food product are inspected to determine whether the wrapping properly envelops the substantially solid food product.

10. A system for non-invasively inspecting a solid chocolate food product comprising:
a. a magnetic resonance imaging device to generate at least one magnetic resonance image of said solid chocolate food product;
b. at least one magnetic resonance image of at least one standardized control sample of said solid chocolate food product; and
c. a processor to compare said at least one magnetic resonance image of said solid chocolate food product to said at least one magnetic resonance image of said at least one standardized control sample of solid chocolate food product;
wherein blooming can be detected on the surface of said solid chocolate food product, further wherein said solid chocolate food product is at least substantially enclosed in a substantially flexible aluminum foil wrapper, and further wherein said solid chocolate food product is in a random orientation with respect to said magnetic resonance imaging device.

11. The system for non-invasively inspecting a solid chocolate food product according to claim 10, wherein at least one of the following is being held true: (a) said system further comprising a magnetic resonance probe for supporting said Al foil wrapper in said magnetic resonance imaging device during a magnetic resonance measurement of said slid chocolate food product; (b) said Al foil wrapper has a thickness in the range of approximately 6 μm to approximately 20 μm; (c) said magnetic resonance device generates a magnetic field intensity of approximately 1 Tesla in a region of interest; (d) said Al wrapping foil has a skin depth of approximately 13 μm in an RF frequency range of approximately 42.5 MHz to 45 MHz; and any combination thereof.

12. The system for non-invasively inspecting a solid chocolate food product according to claim 10, wherein said magnetic field intensity has a skin depth of approximately 13 μm in said Al foil wrapper.

13. The system for non-invasively inspecting a solid chocolate food product according to claim 10, wherein said magnetic resonance imaging device is an MRD device.

14. The system for non-invasively inspecting a solid chocolate food product according to claim 10, wherein items of solid chocolate food product are inspected to determine whether the wrapping properly envelops the substantially solid food product.

15. A method for non-invasively inspecting a substantially solid food product comprising:
a. acquiring a system for non-invasively inspecting a substantially solid food product, said system comprising:
i. a magnetic resonance imaging device to generate at least one magnetic resonance image of said substantially solid food product; and
ii. a processor to compare said at least one magnetic resonance image of said substantially solid food product to at least one magnetic resonance image of at least one standardized control sample of said substantially solid food product;
b. making at least one magnetic resonance image of at least one standardized control sample of said substantially solid food product;
c. making at least one magnetic resonance image of said substantially solid food product;
d. comparing said at least one magnetic resonance image of said substantially solid food product with said at least one magnetic resonance image of said at least one standardized control sample of said substantially solid food product;
wherein defects are detectable in said substantially solid food product, wherein said substantially solid food product is at least substantially enclosed in a substantially flexible aluminum foil wrapper, and further wherein said substantially solid food product is in a random orientation with respect to said magnetic resonance imaging device.

16. The method for non-invasively inspecting a substantially solid food product according to claim 15, further comprising at least one step selected from a group consisting of (a) storing said at least one magnetic resonance image of at least one standardized control sample of said substantially solid food product; (b) providing a magnetic resonance probe for supporting said Al foil wrapper in said magnetic resonance imaging device during said magnetic resonance measurement of said substantially solid food product; (c) selecting a thickness for said Al foil wrapper in the range of approximately 6 μm to approximately 20 μm; (d) generating a magnetic field intensity of approximately 1 Tesla in a region of interest; (e) generating a magnetic field, wherein said magnetic field intensity has a skin depth of approximately 13 μm in said Al foil wrapper; and any combination thereof.

17. The method for non-invasively inspecting a substantially solid food product according to claim 15, further comprising a step of selecting an MRD device as said magnetic resonance imaging device.

18. The method for non-invasively inspecting a substantially solid food product according to claim 15, further comprising at least one step selected from a group consisting of (a) establishing a skin depth of approximately 13 μm in said Al wrapping foil; RF frequency range of said magnetic resonance imaging device being approximately 42.5 MHz to 45 MHz; (b) inspecting items of substantially solid food product to determine whether the wrapping properly envelops the substantially solid food product; and any combination thereof.

19. A method for non-invasively inspecting a solid chocolate food product comprising:
a. acquiring a system for non-invasively inspecting a solid chocolate food product, said system comprising:
i. a magnetic resonance imaging device to generate at least one magnetic resonance image of said solid chocolate food product; and
ii. a processor to compare said at least one magnetic resonance image of said solid chocolate food product to at least one magnetic resonance image of at least one standardized control sample of said solid chocolate food product;
b. making at least one magnetic resonance image of at least one standardized control sample of said solid chocolate food product;
c. making at least one magnetic resonance image of said solid chocolate food product;
d. comparing said at least one magnetic resonance image of said solid chocolate food product with said at least one magnetic resonance image of said at least one standardized control sample of said solid chocolate food product;
wherein defects are detectable on the surface of said wrapped solid chocolate food product, further wherein said solid chocolate food product is at least substantially enclosed in a substantially flexible aluminum foil wrapper and further wherein said substantially solid food product is in a random orientation with respect to said magnetic resonance imaging device.

20. The method for non-invasively inspecting a substantially solid food product according to claim 19, further comprising at least one step selected from a group consisting of (a) storing said at least one magnetic resonance image of at least one standardized control sample of said solid chocolate food product; (b) providing a magnetic resonance probe for supporting said Al foil wrapper in said magnetic resonance imaging device during said magnetic resonance measurement of said solid chocolate food product; (c) selecting a thickness for said Al foil wrapper in the range of approximately 6 μm to approximately 20 μm; (d) generating a magnetic field intensity of approximately 1 Tesla in a region of interest; (e) generating a magnetic field, wherein said magnetic field intensity has a skin depth of approximately 13 μm in said Al foil wrapper; (f) selecting an MRD device as said magnetic resonance imaging device; (g) establishing a skin depth of approximately 13 μm in said Al wrapping foil; RF frequency range of said magnetic resonance imaging device being approximately 42.5 MHz to 45 MHz; (h) inspecting items of solid chocolate food product to determine whether the wrapping properly envelops the solid chocolate food product; and any combination thereof.
